(19) United States
(12) Patent Application Publication
(10) Pub. No.: US 2026/0220971 A1
(43) Pub. Date: Jul. 30, 2026

(54) IMAGE PROCESSING APPARATUS AND IMAGE PROCESSING METHOD

(71) Applicant: CANON KABUSHIKI KAISHA, Tokyo (JP)

(72) Inventor: Yuya HONDA, Kanagawa (JP)

(21) Appl. No.: 19/454,480

(22) Filed: Jan. 21, 2026

(30) Foreign Application Priority Data
Jan. 27, 2025 (JP) 2025-011659

(51) Int. Cl. G06V 40/20; G06V 10/26; G06V 10/776; G06V 40/10; G06V 40/16; H04N 23/611

(52) U.S. Cl. CPC G06V 40/23; G06V 10/26; G06V 10/776; G06V 40/10; G06V 40/161; H04N 23/611

(57) ABSTRACT

An image processing apparatus includes an image input unit that inputs an image, a person detection unit that detects a person included in the image, an action type detection unit that detects an action type of the detected person, and a priority assignment unit that assigns a predetermined priority for each action type in accordance with the action type of the detected person.

### BACKGROUND

### Field of the Technology

The present disclosure relates to a technical field in which a specific subject is selected from a plurality of subjects included in an image.

### Description of the Related Art

An image capture apparatus such as a digital camera is configured to select a specific subject from a plurality of subjects included in an image and perform control to focus on the selected subject as a control target, control to maintain an in-focus state, and the like. As a method of determining a specific subject, Japanese Patent Laid-Open No. 2009-118009 discloses a method of designating conditions such as the age, sex, and facial expression of a target to be shot and recording an image of a subject satisfying the conditions among a plurality of subjects. In addition, Japanese Patent Laid-Open No. 2021-82944 discloses a method of selecting a specific subject from the movement of the image capture apparatus and the type of subject.

However, according to Japanese Patent Laid-Open Nos. 2009-118009 and 2021-82944, in a case where the actions of a plurality of subjects have some relation with each other as in sports (for example, in a case where players are switched between, for example, offense and defense), it is difficult to select a specific subject.

### SUMMARY

The present disclosure has been made in consideration of the aforementioned problems, and provides technical advantages in selecting a specific subject based on the relation between the actions of a plurality of subjects.

In order to solve the aforementioned problems, the present disclosure is directed to an image processing apparatus comprising: at least one processor; and at least one memory which stores a program which, when executed by the at least one processor, causes the image processing apparatus to function as: an image input unit that inputs an image; a person detection unit that detects a person included in the image; an action type detection unit that detects an action type of the detected person; and a priority assignment unit that assigns a predetermined priority for each action type in accordance with the action type of the detected person.

According to the present disclosure, a specific subject can be selected based on the relation between the actions of a plurality of subjects.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A and 1B are block diagrams exemplarily showing apparatus configurations according to a first embodiment;

FIG. 2 is a flowchart exemplarily showing priority assignment processing according to the first embodiment;

FIG. 3 is a view exemplarily showing a priority assignment model according to the first embodiment;

FIGS. 4A and 4B are views for explaining an application example of the first embodiment;

FIG. 5 is a functional block diagram exemplarily showing an apparatus configuration according to a second embodiment;

FIG. 6 is a flowchart exemplarily showing priority assignment processing according to the second embodiment;

FIGS. 7A to 7C are views for explaining an application example of the second embodiment;

FIGS. 8A and 8B are views exemplarily showing a priority model according to the second embodiment;

FIG. 9 is a functional block diagram exemplarily showing an apparatus configuration according to a third embodiment;

FIG. 10 is a flowchart exemplarily showing priority assignment processing according to the third embodiment;

FIGS. 11A to 11C are views for explaining an application example of the third embodiment;

FIGS. 12A and 12B are views exemplarily showing a priority model according to the third embodiment;

FIG. 13 is a functional block diagram exemplarily showing an apparatus configuration according to a fourth embodiment;

FIG. 14 is a flowchart exemplarily showing priority assignment processing according to the fourth embodiment;

FIGS. 15A to 15E are views for explaining an application example of the fourth embodiment;

FIGS. 16A and 16B are views exemplarily showing a priority model according to the fourth embodiment;

FIG. 17 is a functional block diagram exemplarily showing an apparatus configuration according to the fourth embodiment;

FIG. 18 is a flowchart exemplarily showing priority assignment processing according to a fifth embodiment;

FIGS. 19A to 19C are views for explaining an application example of the fifth embodiment;

FIGS. 20A and 20B are views exemplarily showing a priority model according to the fifth embodiment;

FIG. 21 is a functional block diagram exemplarily showing an apparatus configuration according to a sixth embodiment;

FIG. 22 is a flowchart exemplarily showing priority assignment processing according to the sixth embodiment;

FIGS. 23A to 23C are views for explaining an application example of the sixth embodiment;

FIGS. 24A and 24B are views exemplarily showing a priority model according to the sixth embodiment;

FIG. 25 is a functional block diagram exemplarily showing an apparatus configuration according to a seventh embodiment;

FIG. 26 is a flowchart exemplarily showing priority assignment processing according to the seventh embodiment;

FIGS. 27A to 27C are views for explaining an application example of the seventh embodiment; and

FIGS. 28A and 28B are views exemplarily showing a priority model according to the seventh embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

The present embodiment will exemplify a case where an image capture apparatus such as a digital camera transmits the images obtained by capturing sport scenes to an image processing apparatus, and the image processing apparatus detects the action types of a plurality of subjects from the images obtained from the image capture apparatus and assigns priorities to the action types of the plurality of subjects by using a priority model in which action types and their priorities are defined.

### First Embodiment

A first embodiment will be described below.

### <Hardware Configuration>

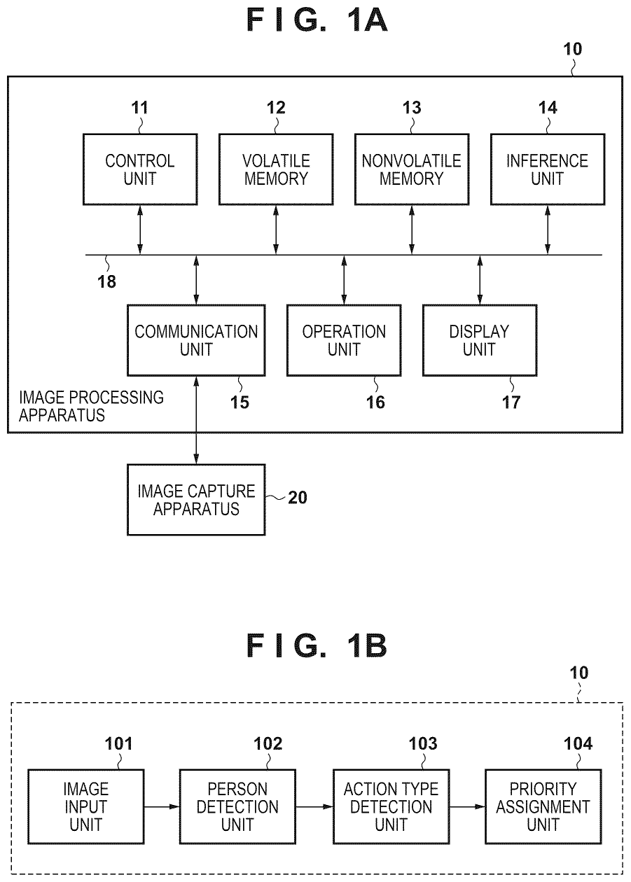

The hardware configuration of the image processing apparatus according to the present embodiment will be described first with reference to FIG. 1A.

FIG. 1A is a block diagram showing the hardware configuration of an image processing apparatus 10 according to the present embodiment.

The image processing apparatus 10 includes a control unit 11, a volatile memory 12, a nonvolatile memory 13, an inference unit 14, a communication unit 15, an operation unit 16, and a display unit 17. The respective constituent elements are connected to each other via an internal bus 18 so as to be able to transmit and receive data.

The control unit 11 has a processor (CPU) that performs arithmetic processing and control processing by the image processing apparatus 10 and controls the respective constituent elements of the image processing apparatus 10 by executing control programs stored in the nonvolatile memory 13.

The volatile memory 12 is a main storage device such as a RAM. The volatile memory 12 is loaded with constants and variables for the operation of the control unit 11, the control program or inference program read out from the nonvolatile memory 13, a priority model (to be described later), and the like. The volatile memory 12 stores the image data received from an image capture apparatus 20 via the communication unit 15, the inference program received from an external apparatus, the priority model, and the like. The volatile memory 12 has a sufficient storage capacity for holding these pieces of information.

The nonvolatile memory 13 is an auxiliary storage device such as an EEPROM, flash memory, hard disk drive (HDD), solid-state drive (SSD), or memory card. The nonvolatile memory 13 stores an operating system (OS) as basic software executed by the control unit 11, control programs and the like including applications that implement applied functions in cooperation with the OS, the inference program used for inference processing by the inference unit 14, the priority model (to be described later), and the like.

The inference unit 14 executes inference processing using machine learning such as deep learning by using a learned inference model and inference parameters in accordance with the inference program.

The communication unit 15 is an interface (I/F) complying to a wired communication standard such as Ethernet® or an interface complying to a wireless communication standard such as Wi-Fi®. The communication unit 15 is connected to an external apparatus such as the image capture apparatus 20 via a network such as a wired LAN or wireless LAN and can transmit and receive data to and from the external apparatus. The control unit 11 implements communication with the external apparatus by controlling the communication unit 15. Note that the communication scheme is not limited to Ethernet® or Wi-Fi® and may use a communication standard such as IEEE 1394.

The operation unit 16 includes operation members such as various types of switches, buttons, and a touch panel, which output operation information to the control unit 11 upon accepting various types of operations from the user. The operation unit 16 also provides a user interface for enabling the user to operate the image processing apparatus 10.

The display unit 17 performs display of images and subject detection results, display of a graphical user interface (GUI) for interactive operations, and the like. The display unit 17 is a display device such as a liquid crystal display or organic EL display. The display unit 17 may be configured to be integrated with the image processing apparatus 10 or may be an external device connected to the image processing apparatus 10.

The image processing apparatus 10 according to the present embodiment serves as a controller to control the image capture apparatus 20 to select a main subject from a plurality of subjects based on priorities corresponding to the action types of the subjects and focus on the main subject. The image capture apparatus 20 performs control to focus on the main subject selected by the image processing apparatus 10 as a control target, control to maintain an in-focus state, and the like and transmits captured images to the image processing apparatus 10. Note that the image processing apparatus 10 according to the present embodiment may also function as the image capture apparatus 20.

Note that subjects in the present embodiment are persons (competitors) who play sport but may be other moving objects as well as persons.

### <Functional Configuration>

The functional blocks of the image processing apparatus 10 according to the present embodiment will be described next with reference to FIG. 1B.

FIG. 1B is a functional block diagram of the image processing apparatus 10 according to the present embodiment.

The image processing apparatus 10 includes an image input unit 101, a person detection unit 102, an action type detection unit 103, and a priority assignment unit 104. Each function of the image processing apparatus 10 is implemented by hardware and software. Note that each function of the image processing apparatus 10 according to the present embodiment may be implemented by a single apparatus or may be divisionally implemented by a plurality of apparatuses as needed. In this case, the plurality of apparatuses are communicably connected to each other.

The image input unit 101 inputs images from the image capture apparatus 20 or an external apparatus at a predetermined frame rate.

The person detection unit 102 performs person detection with respect to the image obtained from the image input unit 101.

The action type detection unit 103 detects an action type with respect to the person detection result obtained by the person detection unit 102. Action types include labels representing actions that are characteristic to each sport, such as spike, block, and receive in volleyball and labels representing actions that are not characteristic actions, such as a motionless standing posture and a resting posture. In action type detection, an input image is divided into personal images each including a person by using a person detection result, and inference processing is performed by using a learned model by using each divided image as an input, thereby performing feature extraction. The learned model according to the present embodiment is implemented by a neural network, specifically a convolutional neural network (CNN) in the present embodiment. Note that the inference model according to the present embodiment is not limited to the CNN and may be implemented by another type of neural network such as Transformer.

Inference processing according to the present embodiment can be executed by graphics processing unit (GPU) or digital signal processor (DSP). The GPU or DSP is a processor that can perform massive sum-of-product computation, bias addition, nonlinear processing, and the like and has arithmetic processing power that can perform a matrix operation and the like with the neural network in a short time. Note that inference processing may be performed by the CPU of the control unit 11 and the GPU or DSP of the inference unit 14 in cooperation with each other or may be performed by one of the CPU of the control unit 11 and the GPU or DSP of the inference unit 14.

The priority assignment unit 104 assigns a priority to each action type of a person in accordance with the action type detection result obtained by the action type detection unit 103 by using a priority model in which priorities are assigned to the respective action types. Priority assignment is performed for each action type of a person detected by the person detection unit 102 and the action type detection unit 103.

Note that priorities assigned in the present embodiment can be used in combination with priorities assigned based on another standard. If, for example, three are a plurality of persons assigned with the same priority in the present embodiment, higher priorities may be assigned to persons located nearer to the center of the image. In addition, an input image in the present embodiment is not limited to a single image, and consecutive images may be input and processed.

### <Priority Assignment Processing>

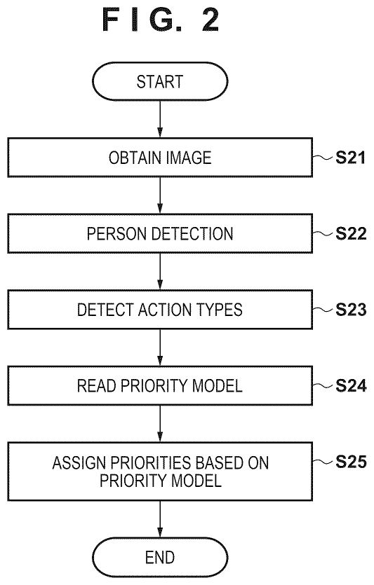

Priority assignment processing according to the present embodiment will be described next with reference to FIG. 2.

FIG. 2 is a flowchart exemplarily showing priority assignment processing according to the present embodiment.

The control unit 11 implements the processing in FIG. 2 by executing the programs stored in the nonvolatile memory 13 and controlling the respective constituent elements in FIG. 1A so as to function as the respective constituent elements in FIG. 1B. The processing in FIG. 2 is executed for all the persons included in the image.

In step S21, the image input unit 101 inputs an image from the image capture apparatus 20.

In step S22, the person detection unit 102 performs person detection with respect to the image input in step S21.

In step S23, the action type detection unit 103 detects the action types of the persons detected in step S22.

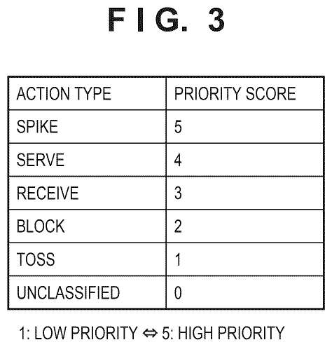

In step S24, the priority assignment unit 104 reads the priority model from the nonvolatile memory 13. The priority model is a lookup table or database in which action types and a priority score for each action type are defined. FIG. 3 exemplarily shows a priority model in volleyball. In the example shown in FIG. 3, the priority scores of spike, serve, receive, block, and toss as action types are respectively defined as 5, 4, 3, 2, and 1, and the priority scores of unclassified actions including actions other than playing actions, such as motionless standing and resting are defined as 0. Note that the priority model can be changed depending on sport and may be changed in accordance with the determination result obtained by determining sport from an input image as well as being changed by the user in accordance with sport. In addition, the priority model allows the redefinition of priorities in accordance with action types, and higher priority scores may be defined in the order of action types to which the user wants to assign higher priority scores.

In step S25, the priority assignment unit 104 assigns priorities to the respective action types of the persons detected in step S23 by using the priority model read in step S24.

### <Application Example>

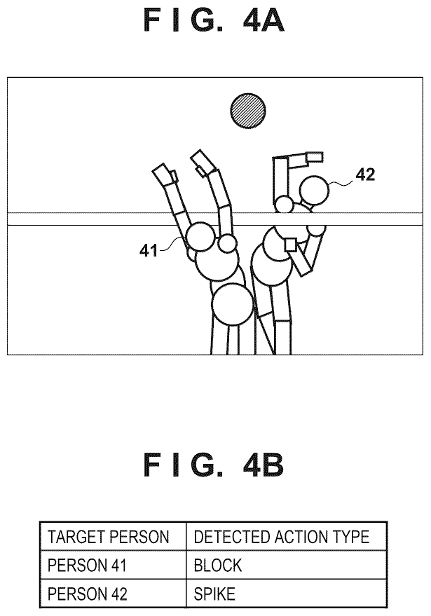

An application example of the present embodiment will be described next with reference to FIGS. 4A and 4B.

In the present embodiment, the action type of a person with a higher priority is specified among the persons performing different actions detected by the action type detection unit 103.

FIG. 4A exemplarily shows a scene in which a spike and a block occur at the same time in volleyball.

A person 41 is performing a blocking action, and a person 42 is performing a spiking action. The person detection unit 102 detects the persons 41 and 42. The action type detection unit 103 detects action types such that the action type of the person 41 is spike, and the action type of the person 42 is block as shown in FIG. 4B.

In a case where the priority model exemplarily shown in FIG. 3 is used, the person 41 is assigned with a priority score of 2 corresponding to the action type “block”, and the person 42 is assigned with a priority score of 5 corresponding to the action type “spike”.

Comparing the priority scores corresponding to the action types of the persons 41 and 42 will specify the person 42, who is higher in priority score than the person 41, as a person with high priority.

In this manner, a person with high priority can be specified among a plurality of persons performing different actions.

Although the present embodiment has exemplified the case of using the priority model in which priority scores are defined with respect to all the action types expected in sport as a control target, a priority model describing only persons and action types to be prioritized may be used. Referring to FIG. 4A, in a case where the priority model describing only spike is used, detecting the person 42 who is performing a spiking action will assign a priority score to only the person 42 and can specify the person 42 as a person with high priority.

### Second Embodiment

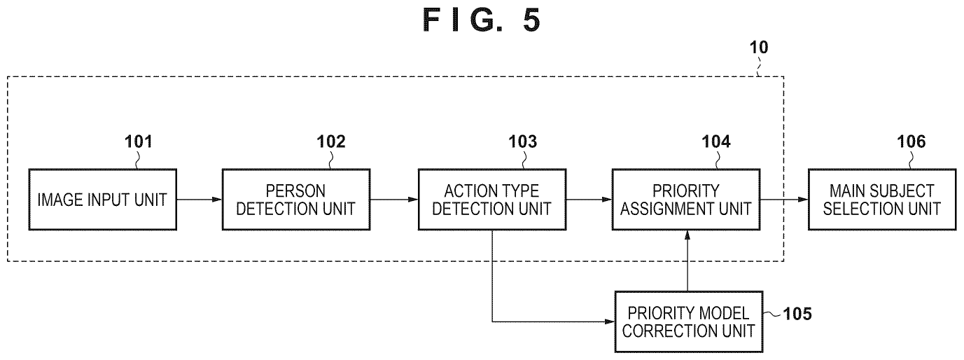

A second embodiment will be described next with reference to FIGS. 5 to 8B.

The hardware configuration of an image processing apparatus 10 according to the present embodiment is the same as that of the first embodiment in FIG. 1A. The functional configuration of the image processing apparatus 10 according to the present embodiment is the same as that of the first embodiment except that the configuration shown in FIG. 1B further includes a priority model correction unit 105 and a main subject selection unit 106.

The priority model correction unit 105 corrects a priority model in accordance with a combination of two or more action types detected by an action type detection unit 103.

A priority assignment unit 104 assigns a priority in accordance with the action type of each person detected by the action type detection unit 103 by using the priority model corrected by the priority model correction unit 105.

The main subject selection unit 106 determines a main subject based on the priority assigned by the priority assignment unit 104.

### <Priority Model Correction Processing and Priority Assignment Processing Using Corrected Priority Model>

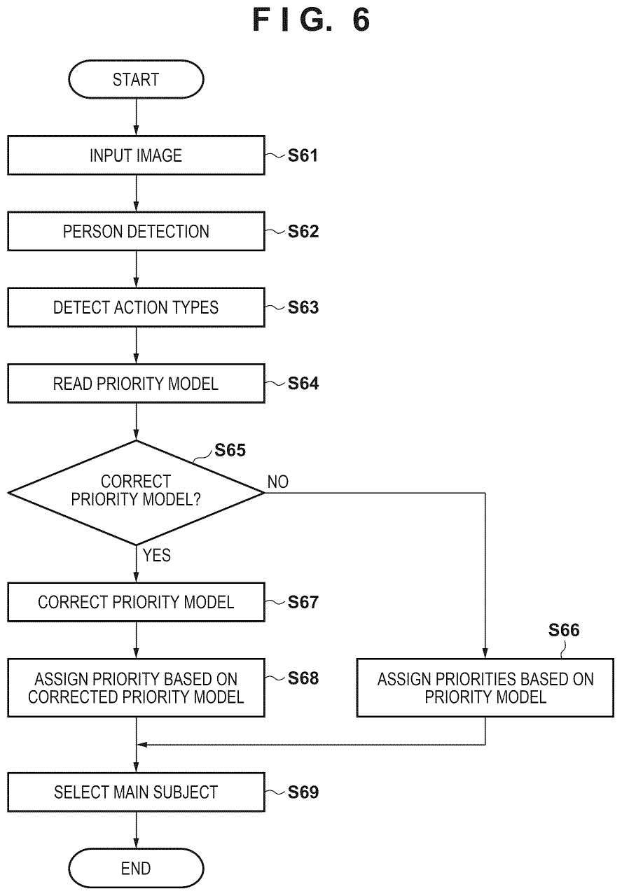

Priority assignment processing according to the second embodiment will be described next with reference to FIG. 6.

Note that the processing in steps S61 to S64 in FIG. 6 is the same as that in steps S21 to S24 in FIG. 2.

After the processing in steps S61 to S64, the priority model correction unit 105 determines in step S65 whether it is necessary to correct the priority model in accordance with a combination of two or more action types detected in step S63. A case where it is determined that it is necessary to correct the priority model is a case where there are two or more persons with the same action type in an image and the action type corresponds to the highest priority score in the image. If, for example, there are two or more persons with the same action type in an image and the action type corresponds to the highest priority score, there are two or more persons with the same priority. In such a case, since one person cannot be selected as a main subject, it is necessary to reassign priorities to the persons by some method. Accordingly, the present embodiment is configured to correct the priority model to perform control so as not to select any main subject.

Upon determining that it is not necessary to correct the priority model, the priority assignment unit 104 performs, in step S66, priority assignment by using the priority model read in step S64. When it is necessary to correct the priority model, the priority model correction unit 105 corrects, in step S67, the priority score corresponding to the action type of the two or more persons to 0 in the priority model read in step S64. In addition, the priority scores corresponding to action types lower in priority score than the action type of the two or more persons are also corrected to 0.

In step S68, the priority assignment unit 104 performs priority assignment by using the priority model corrected in step S67.

In step S69, the main subject selection unit 106 selects a person with the highest priority as a main subject by referring to the priorities assigned in step S66 or S68. In selecting a main subject, any person with a priority score of 0 is handled in the same manner as a person irrelevant to play, such as a person in a motionless standing posture or resting posture, and is excluded from main subject candidates. In addition, if the maximum priority score is 0, main subject selection is not executed. In a case where there are two or more persons with the same action type and the action type corresponds to the highest priority score in the image, since the action type and action types lower in rank correspond to a priority score of 0, the maximum priority score to be assigned becomes 0. As a result, main subject selection from the input image is not executed. Accordingly, if a main subject has been selected in an image input in the past, the person is continuously selected as a main subject in an input image under processing.

### <Application Example>

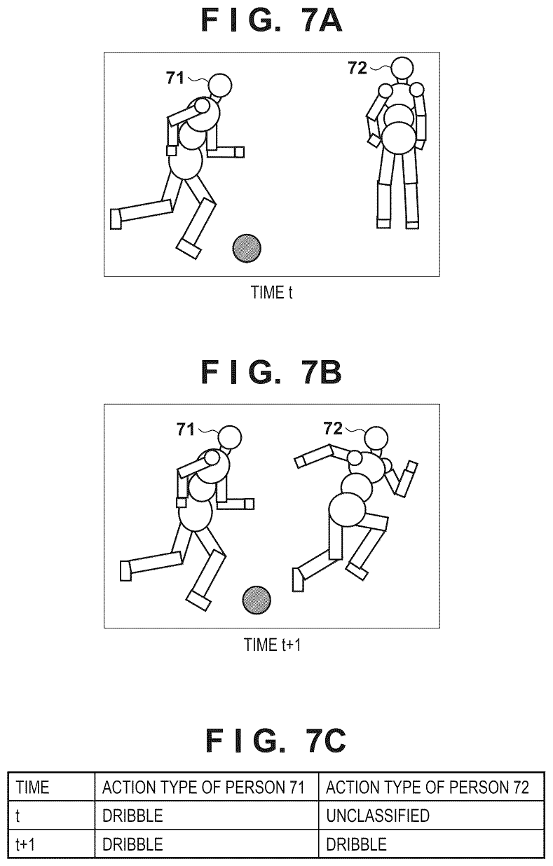

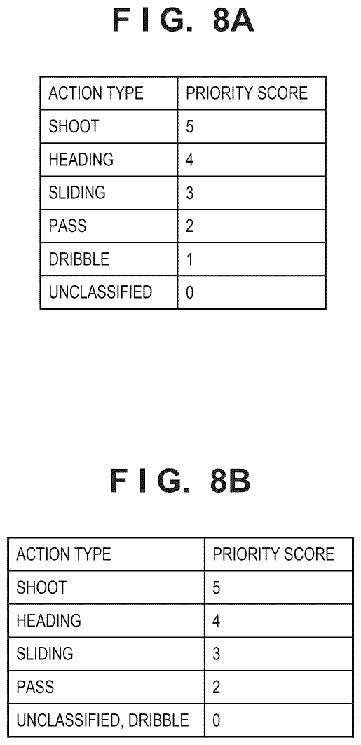

An application example of the present embodiment will be described next with reference to FIGS. 7A to 7C and FIGS. 8A and 8B.

In the present embodiment, in a case where the action type detection unit 103 detects two or more persons with the same action type and the action type corresponds to the highest priority score in an image, the priority model is corrected so as to exclude the detected persons from main subject candidates and continuously select a main subject selected in the past as a main subject.

FIGS. 7A and 7B show a scene of dribbling in soccer. FIG. 7A exemplarily shows a scene where a person 71 is dribbling. FIG. 7B exemplarily shows a scene where both the person 71 and a person 72 are competing in dribbling. FIGS. 7A and 7B are consecutive images. FIG. 7A shows the image at time t. FIG. 7B shows the image at time t+1.

Referring to FIGS. 7A and 7B, the person detection unit 102 detects the person 71 and the person 72. As shown in FIG. 7C, the action type detection unit 103 respectively detects the action types of the person 71 and the person 72 as dribble and unclassified in FIG. 7A, and detects the action types of the person 71 and the person 72 as dribble in FIG. 7B.

FIGS. 8A and 8B exemplarily show priority models in soccer. FIG. 8A exemplarily shows a priority model before correction. FIG. 8B exemplarily shows a corrected priority model.

Referring to FIG. 7A, since there is only a single action type, priorities are assigned by using the priority model shown in FIG. 8A. Since priority scores are assigned in accordance with action types defined in the priority model, a priority score of 1 is assigned to the person 71, and a priority score of 0 is assigned to the person 72. Accordingly, the person 71 has the highest priority and hence is selected as a main subject in the scene in FIG. 7A.

Referring to FIG. 7B, the action types of the person 71 and the person 72 are both dribble, and there are no action types corresponding to higher priority scores. Accordingly, as shown in FIG. 8B, the priority model is corrected. In the corrected priority model in FIG. 8B, the priority score of dribble is corrected to 0 with respect to the priority model in FIG. 8A, which is the lowest score and regarded as unclassified. Priorities are assigned by using the corrected priority model, and the priority scores of the person 71 and the person 72 are both 0, so that the persons with a priority score of 0 are excluded from main subject candidates in main subject selection. As a result, main subject switching is not performed in FIG. 7B, and the person 71 selected as a main subject in FIG. 7A is continuously selected as a main subject in FIG. 7B. In a case where there are two or more dribbling persons, this processing can solve a problem that main subject switching frequently occurs depending on a control method when the image capture apparatus 20 tracks a main subject.

### Third Embodiment

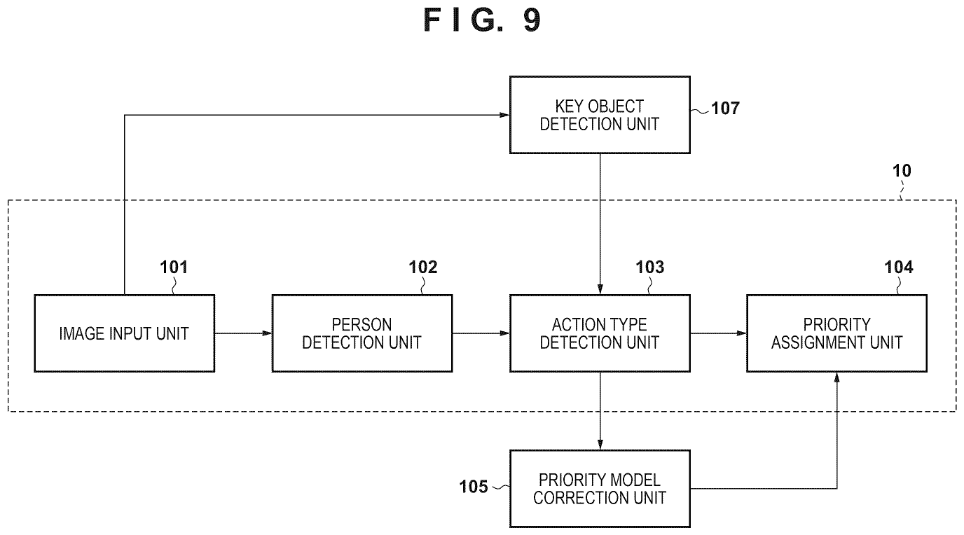

A third embodiment will be described next with reference to FIGS. 9 to 12B.

The hardware configuration of an image processing apparatus 10 according to the present embodiment is the same as that of the first embodiment shown in FIG. 1A. FIG. 9 is a block diagram exemplarily showing the functional configuration of the image processing apparatus 10 according to the present embodiment. The functional configuration of the image processing apparatus 10 according to the present embodiment is the same as that of the first embodiment except that the configuration in FIG. 1B further includes a priority model correction unit 105 and a key object detection unit 107.

The key object detection unit 107 detects a key object in an image input by an image input unit 101. A key object is an important object commonly used in a sport scene, such as a ball in soccer, a ball in volleyball, or a shuttlecock in badminton. A key object detection result is input to an action type detection unit 103. The action type detection unit 103 sets the action type of a person having a predetermined relationship with a key object to an action type that is differentiated from the action type of one or more other persons performing the same action based on the key object detection result. The priority model correction unit 105 corrects the priority model in accordance with a combination of a plurality of action types detected by the action type detection unit 103.

The processing of assigning different action types to specific persons and the processing of correcting the priority model by using a key object detection result will be described later.

### <Key Object Detection Processing and Priority Model Correction Processing>

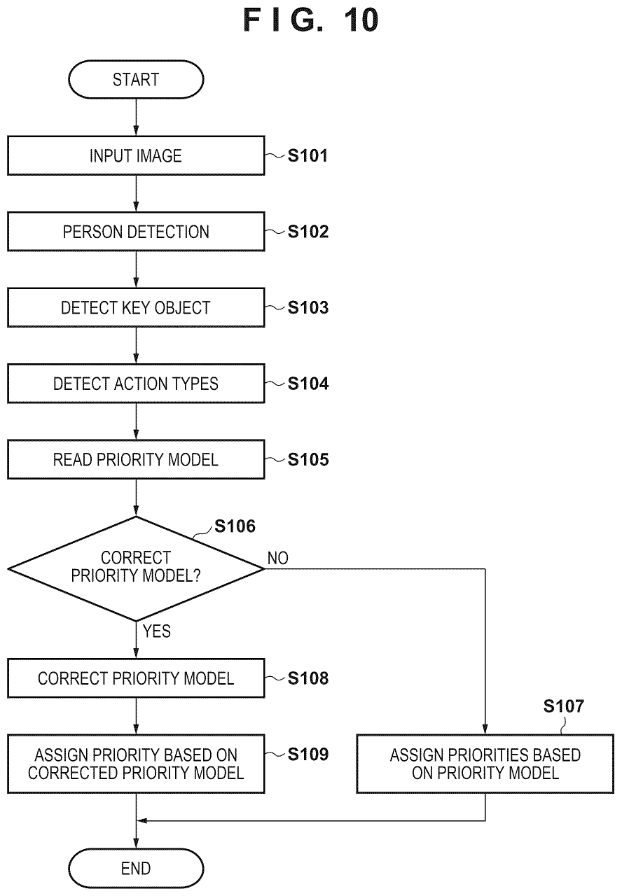

Priority assignment processing according to the third embodiment will be described next with reference to FIG. 10.

Note that the processing in steps S101, S102, and S104 to S109 in FIG. 10 is the same as that in steps S61, S62, and S63 to S68 in FIG. 6.

After the processing in steps S101 and S102, the key object detection unit 107 detects, in step S103, a key object in the image input in step S101.

In step S104, the action type detection unit 103 detects action types with respect to the persons detected in step S102 as in the first embodiment. In addition, the action type detection unit 103 specifies a person located nearest to the key object among the persons with the same action type by using the key object detection result and the person detection result and sets the action type of the specified person to an action type that is differentiated from the action type of one or more other persons performing the same action. It is possible to specify a person nearest to the key object by calculating the distances between the positions of the centers of gravity of the detected persons and the position of the center of gravity of the key object and selecting a person corresponding to the minimum distance. In a case where no key object can be detected, this processing avoids the configuration of prioritizing the action type of a person nearest to the ball.

In step S105, a priority model is read. In step S106, it is determined whether it is necessary to correct the priority model. A case where it is necessary to correct the priority model is a case where there is the differentiated action type set in step S104. In a case where it is determined that it is not necessary to correct the priority model, in step S107, the priority assignment unit 104 performs priority assignment by using the priority model read in step S105. In a case where it is necessary to correct the priority model, the priority assignment unit 104 adds, in step S108, the differentiated action type set in step S104 and the definition of the corresponding priority score to the priority model read in step S105. It is preferable to assign a priority score higher than that of an action type before correction and lower than a priority score corresponding to an action type higher in rank than the action type before correction.

In step S109, a priority assignment unit 104 performs priority assignment by using the priority model corrected in step S108.

### <Application Example>

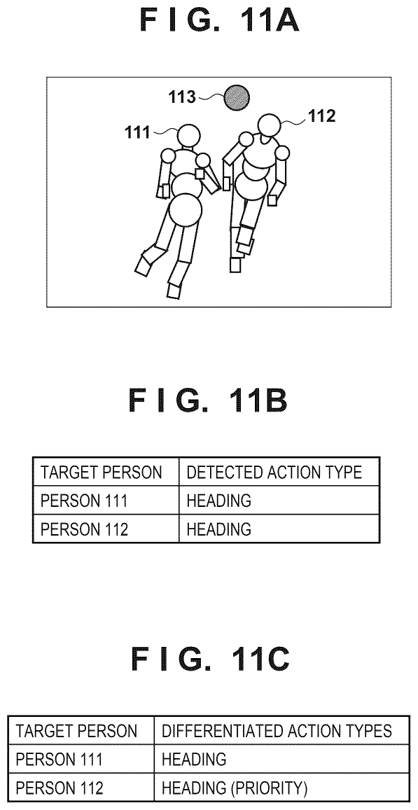

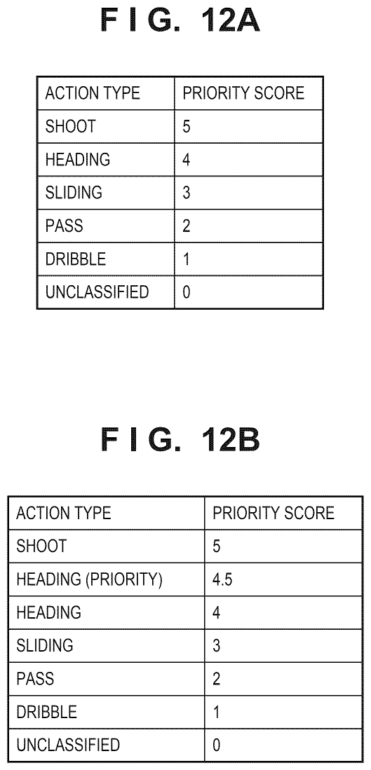

An application example of the present embodiment will be described next with reference to FIGS. 11A to 11C and FIGS. 12A and 12B.

With regard to an action type in a case where main subject switching does not frequently occur, such as dribbling, as described in the second embodiment, if a person nearest to the ball is selected as a main subject, main subject switching may frequently occur. With regard to an action type in a case where a main subject momentarily determined, such as shoot or spike, using a key object detection result makes it easy to select a person nearest to the ball as a main subject in a scene nearer to the moment when the ball is touched.

In the present embodiment, it is possible to specify a person with higher priority among a plurality of persons from which the same action type has been detected based on a key object detection result.

FIG. 11A exemplarily shows a scene where two persons are competing in heading in soccer. In the example shown in FIG. 11A, the person detection unit 102 detects a person 111 and a person 112, and the action type detection unit 103 detects that the action types of the person 111 and the person 112 are both heading. FIG. 11B exemplarily shows an action type detection result with respect to the image shown in FIG. 11A.

Referring to FIG. 11A, a ball 113 is nearer to the person 112 than the person 111, and it is expected that the person 112 will control the ball and perform an important play in heading in subsequent frames. Accordingly, in a scene where two or more persons perform the same action, as shown in FIG. 11A, a person with higher priority is specified based on the distances to the ball.

The action type detection unit 103 calculates the distances between the positions of the centers of gravity of the person 111 and the person 112 and the position of the center of gravity of the ball 113. Since the distance between the person 112 and the ball 113 is shorter than that between the person 111 and the ball 113, the action type of the person 112 nearest to the ball is set to an action type that is differentiated from an action type of another person performing the same action, as shown in FIG. 11C. In the example shown in FIG. 11C, the action type of the person 112 is set to heading (prioritized) to be differentiated from the action type of another person performing the same action.

In a case where the action type detection result obtained by the action type detection unit 103 includes a differentiated action type, the priority model correction unit 105 corrects the priority model by adding the differentiated action type to the priority model. FIG. 12A exemplarily shows a priority model before correction. FIG. 12B exemplarily shows a corrected priority model. In the present embodiment, it is preferable to set a priority corresponding to a differentiated action type within the range in which the priority is higher than a priority corresponding to the same action type before correction and is lower than priorities corresponding to higher-rank action types. In the example shown in FIG. 12B, a priority score of 4.5, which is higher than that of the action type before correction by 0.5, is assigned. Assigning priorities by using the corrected priority model shown in FIG. 12B makes it possible to assign a higher priority to the person 112 expected to control the ball in FIG. 11A.

The second embodiment has exemplified the case where if there are a plurality of persons with the same action type, the priority model is corrected to exclude persons with the same action type from main subject candidates. The third embodiment has exemplified the case where if there are a plurality of persons with the same action type, the priority model is corrected based on a key object detection result to specify a person with higher priority.

In contrast to the above, the second and third embodiments may be combined to switch the processing depending on the characteristics of action types such that the processing according to the first embodiment is performed for an action type for which it is preferable to continuously select a main subject, such as dribble in soccer, and the processing according to the second embodiment is performed for an action type for which it is preferable to momentarily select a main subject, such as heading.

### Fourth Embodiment

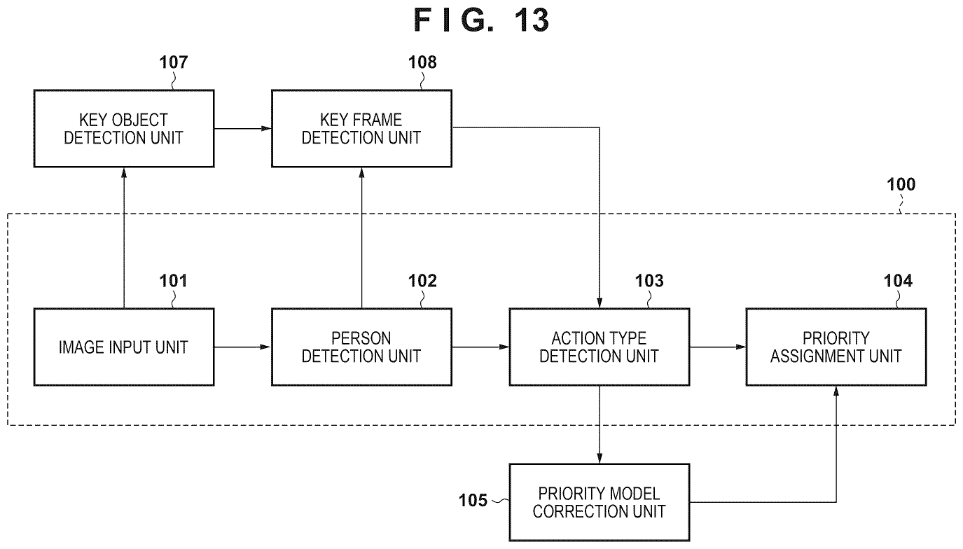

A fourth embodiment will be described next with reference to FIGS. 13 to 16B.

The hardware configuration of an image processing apparatus 10 according to the present embodiment is the same as that of the first embodiment shown in FIG. 1A. FIG. 13 is a block diagram exemplarily showing the functional configuration of the image processing apparatus 10 according to the present embodiment. The functional configuration of the image processing apparatus 10 according to the present embodiment is the same as that of the third embodiment except that the configuration in FIG. 9 further includes a key frame detection unit 108.

The key frame detection unit 108 detects a key frame based on the persons detected by a person detection unit 102 and the key object detection result obtained by a key object detection unit 107. A key frame is an image depicting the moment when a person moves nearest to or away from a key object while performing actions such as catch and pass in a sport scene.

A key frame detection result is input to an action type detection unit 103. The action type detection unit 103 sets the action type of the person having a predetermined relationship with the key frame to an action type to be differentiated from the action type of one or more other persons performing the same action based on the key frame detection result. A priority model correction unit 105 performs correction to reduce the priority score of the action type of the person who has passed the key frame based on the action type detection result obtained by the action type detection unit 103. Such correction is performed because the action type of a person who has passed a key frame is less likely to become the action of a main subject. This relatively increases the priority of a person performing a different action. Accordingly, the person is likely to be selected as a main subject.

### <Key Frame Detection Processing and Priority Model Correction Processing>

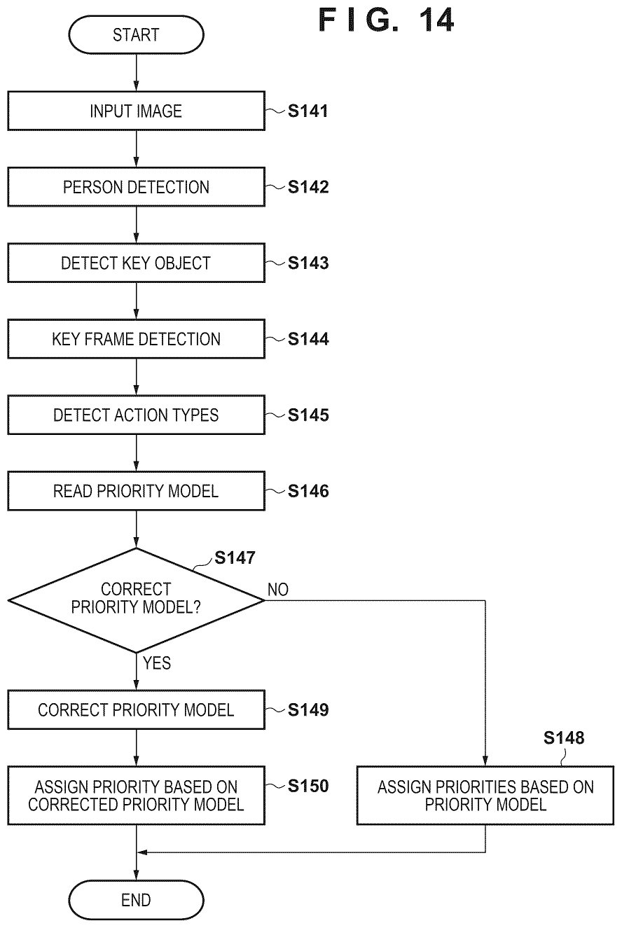

Priority assignment processing according to the fourth embodiment will be described next with reference to FIG. 14.

The processing in steps S141 to S143 and S145 to S150 in FIG. 14 is the same as that in steps S101 to S103 and S104 to S109 in FIG. 10.

After the processing in steps S141 to S143, the key frame detection unit 108 detects, in step S144, a key frame based on the person detected in step S142 and the key object detected in step S143. A key frame is determined from the transition of distance changes based on the calculation of the distance between two points, that is, the position of the person and the position of the key object. More specifically, a condition for a change in distance in an action of receiving a ball can be defined as a case where the distance between a person and a key object is larger than a distance threshold in past few frames and is equal to or smaller than the threshold in the current frame. In addition, a condition for a change in distance in an action of releasing a ball can be defined as a case where the distance between a person and a key object is equal to or less than a threshold in past few frames and is larger than the threshold in the current frame. In a case where a change in distance in past few frames and the current frame corresponds to the above condition, the current frame can be determined as a key frame. Note that the distance threshold is a distance that is used to determine that a person has sufficiently moved near to a key object and is preferably set to a value that differs little between persons, such as the head sizes of the persons, and does not change with a change in the direction or posture of each person.

Instead of referring to the positions of the centers of gravity as the positions of a person and a key object, it is possible to refer to the positions of joints of the hand or foot touching a ball upon providing a detection unit for detecting joints of persons in order to detect a key frame more accurately. In this case, joints touching a ball may be defined for each action type, and joint positions to be referred to as the position of a person may be switched in accordance with an action type detection result. For example, a joint position of the foot is defined to be referred to if the action type is kick, and a joint position of the top of the head is defined to be referred to if the action type is heading. This makes it possible to detect a more accurate key frame.

In step S145, the action type detection unit 103 detects the action type of the person detected in step S142 as in the first embodiment. In addition, with regard to the action type detection result, the action type detection unit 103 sets the action type of the person who has passed one or more frames to an action type that is differentiated from the action type of a person performing a different action.

In step S146, a priority model is read. In step S147, it is determined whether it is necessary to correct the priority model. A case where it is determined that it is necessary to correct the priority model is a case where the action type detection result obtained in step S145 includes a differentiated action type. When it is determined that it is not necessary to correct the priority model, a priority assignment unit 104 assigns, in step S148, a priority by using the priority model read in step S146. When it is determined that it is necessary to correct the priority model, the priority model correction unit 105 adds, in step S149, the differentiated action type and the definition of the corresponding priority score to the priority model read in step S146. With regard to priority scores, a different action type to be prioritized over the action type of the person who has passed the key frame is determined, and a priority score lower than that of the determined action type is assigned. This is because the possibility of the action type of the person who has passed the key frame being the action of a main subject is low. Accordingly, reducing the priority score makes it easy to select the person performing the different action as a main subject.

In step S150, the priority assignment unit 104 performs priority assignment based on the priority model corrected in step S149.

In a case where after a key frame is detected concerning a given action type, if the action type is not detected in an image, a key frame detection result concerning the action type is discarded upon regarding that the action corresponding to the action type is finished after the passing of the key frame.

### <Application Example>

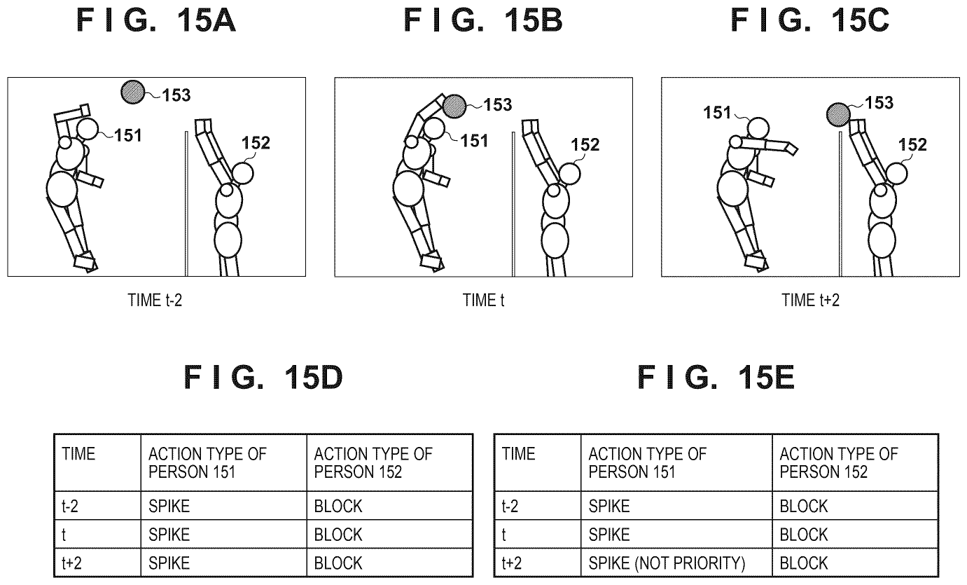

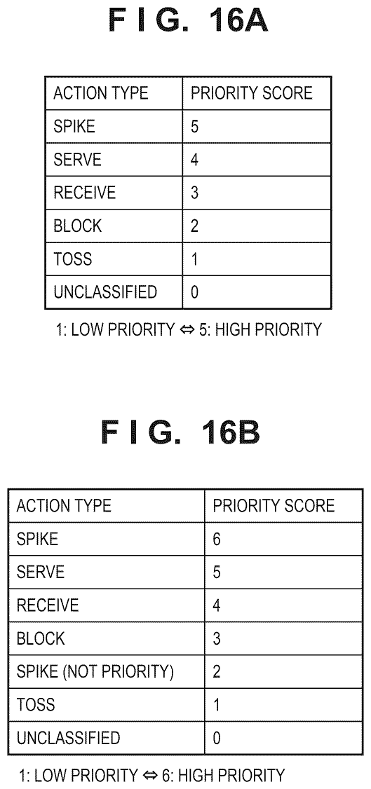

An application example of the fourth embodiment will be described next with reference to FIGS. 15A to 15E and FIGS. 16A and 16B.

In the present embodiment, in a scene where actions consecutively occur, correcting priorities in accordance with action types with reference to the passing of the key frame makes it possible to select persons who sequentially appear and perform important actions as main subjects.

FIGS. 15A to 15E exemplarily show a scene where a spike and a block occur simultaneously in volleyball. FIGS. 15A to 15C show a series of scenes, in each of which a person 151 is performing a spiking action, and a person 152 is performing a blocking action. FIG. 15A exemplarily shows a scene before the person 151 performs spiking. FIG. 15B exemplarily shows the moment when the person 151 performs spiking. FIG. 15C exemplarily shows a scene after the person 151 performs spiking.

The person detection unit 102 detects the persons 151 and 152. The action type detection unit 103 detects spike and block as action types with respect to the scenes in FIGS. 15A to 15C, as shown in FIG. 15D.

FIG. 16A exemplarily shows a priority model before correction. With respect to the scenes in FIGS. 15A to 15C, performing priority assignment based on the priority model in FIG. 16A will assign 5 to the person 151 who is spiking, and 2 to the person 152 who is blocking, and accordingly, the priority of the person 151 who is spiking becomes high. However, in the scene in FIG. 15C, the person 151 has passed the moment of performing spiking, and the moment when the person 152 performs blocking is shown. Accordingly, some user may prioritize the person 152, who is at the moment of blocking, over the person 151, who has passed the moment of spiking. For this reason, in the present embodiment, priority assignment is performed in consideration of whether the action of a person has passed a key frame which is the moment of touching or releasing the ball in addition to action types.

Since the action type of the person 151 is spike, the person is expected to touch the ball above the head. Accordingly, in order to improve the reliability of key frame detection, the reference position of the person is set to the central position of the head, the reference position of the ball is set to the central position of the ball, the distance threshold is set to the three-fold of the size of the head of the person, and the reference period is set to three frames.

Referring to FIG. 15A, the distance between the person 151 and a ball 153 is larger than the threshold and remains the same at time t−1. Referring to FIG. 15B, since the distance between the person 151 and the ball 153 becomes equal to or less than the threshold, it can be determined that the person has received the ball. In FIG. 15B, it is detected that the person 151 is a key frame. After time t+1 corresponding to the frame next to the key frame, the action type of the person 151 who has passed the key frame is set to an action type that is differentiated from the action type of a person who has not passed the key frame. FIG. 15E exemplarily shows the action type detection result obtained by setting the action type of a person who has passed a key frame to an action type that is differentiated from the action type of a person who has not passed the key frame. At time t+2 in FIG. 15E, the action type of the person 151 is set to an action type that is differentiated from a spike (un-prioritized) of the person 151. FIG. 16A exemplarily shows a priority model before correction. FIG. 16B exemplarily shows a corrected priority model. In the example shown in FIG. 16B, the priority score of spike that has passed a key frame is defined as 2, and the priority score of block is 3. Accordingly, the priority of block exceeds that of spike. From time t+1, priority assignment is performed by using the priority model in FIG. 16B, and a priority score of 2 is assigned to the person 151 who is spiking, and a priority score of 3 is assigned to the person 152 who is blocking at time t+1 in FIG. 15C. This makes it possible to assign priorities to the action types of persons who sequentially appear and perform important actions by correcting the priority model with reference to the passing of a key frame in scenes where spiking and blocking consecutively occur.

### Fifth Embodiment

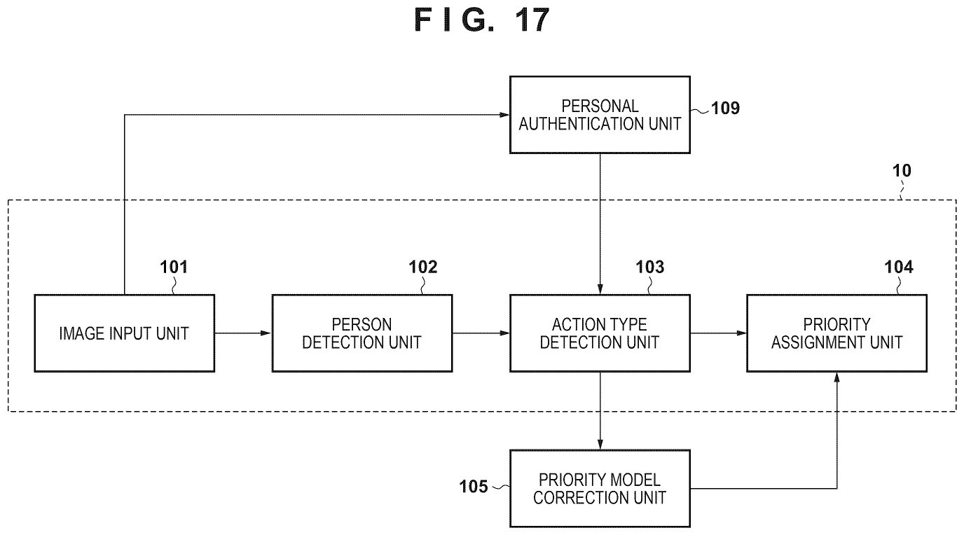

A fifth embodiment will be described next with reference to FIGS. 17 to 20B.

The hardware configuration of an image processing apparatus 10 according to the present embodiment is the same as that of the first embodiment shown in FIG. 1A. FIG. 17 is a block diagram exemplarily showing the functional configuration of the image processing apparatus 10 according to the present embodiment. The functional configuration of the image processing apparatus 10 according to the present embodiment is the same as that of the first embodiment except that the configuration shown in FIG. 1B further includes a personal authentication unit 109 and a priority model correction unit 105.

The personal authentication unit 109 determines, based on the person detection result obtained by a person detection unit 102, whether the face of the detected person matches the features of a face image registered in advance. The personal authentication result obtained by the personal authentication unit 109 is input to an action type detection unit 103. The action type detection unit 103 sets the action type of a person matching a registered person to an action type that is differentiated from that of an unregistered person. The priority model correction unit 105 performs correction to increase the priority score of the person matching the registered person based on the action type detection result obtained by the action type detection unit 103. This makes it possible to assign high priority to the person matching the registered person.

### <Individual Authentication Processing and Priority Model Correction Processing>

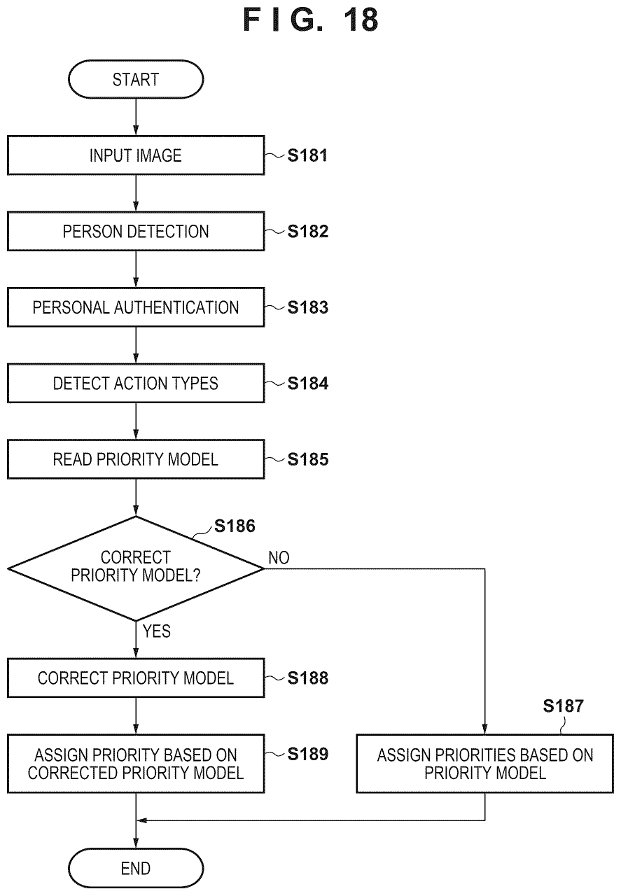

Priority assignment processing according to the present embodiment will be described next with reference to FIG. 18.

The processing in steps S181, S182, and S184 to S189 in FIG. 18 is the same as that in steps S101, S102, and S104 to S109 in FIG. 10.

After the processing in steps S181 and S182, the personal authentication unit 109 performs, in step S183, personal authentication with respect to the person detected in step S182. A person as a target for personal authentication has his/her face image registered in advance. Individual authentication is performed with respect to a person whose face is detected among the persons detected in step S182. Feature amounts are extracted from the face of the registered person and the face of the detected person by inference processing. If the similarity between the two feature amounts is high, it can be determined that the two persons are the same person.

In step S184, the action type detection unit 103 detects the action type of the person detected in step S182 in the same manner as in the first embodiment. The action type detection unit 103 sets a differentiated action type with respect to the person determined to match the registered person in step S183 in accordance with the action type detection result.

In step S185, a priority model is read. In step S186, it is determined whether it is necessary to correct the priority model. A case where it is determined that it is necessary to correct the priority model is a case where the action type detection result obtained in step S184 includes the differentiated action type. When it is determined whether it is not necessary to correct the priority model, the priority assignment unit 104 performs, in step S187, priority assignment by using the priority model read in step S185. When it is determined that it is necessary to correct the priority model, the priority assignment unit 104 adds, in step S188, the differentiated action type and the definition of the corresponding priority score to the priority model read in step S185. The highest priority score is assigned to the differentiated action type.

In step S189, a priority assignment unit 104 performs priority assignment by using the priority model corrected in step S188.

Note that a plurality of persons may be registered, priorities may further be defined with respect to the registered persons, and priority score assignment may be performed in consideration of the priorities of the registered persons in correcting the priority model.

### <Application Example>

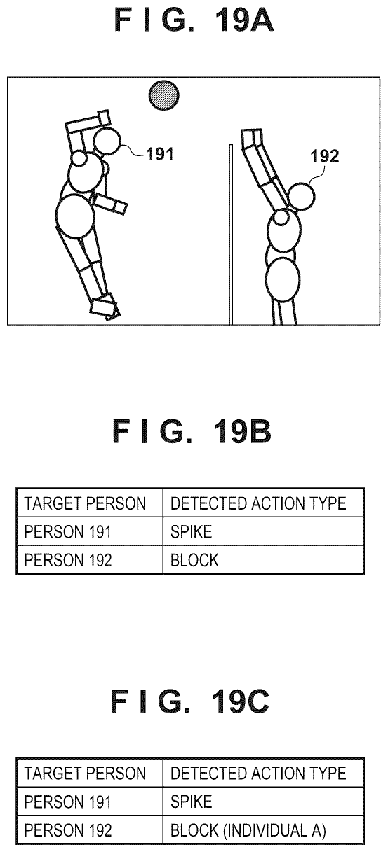

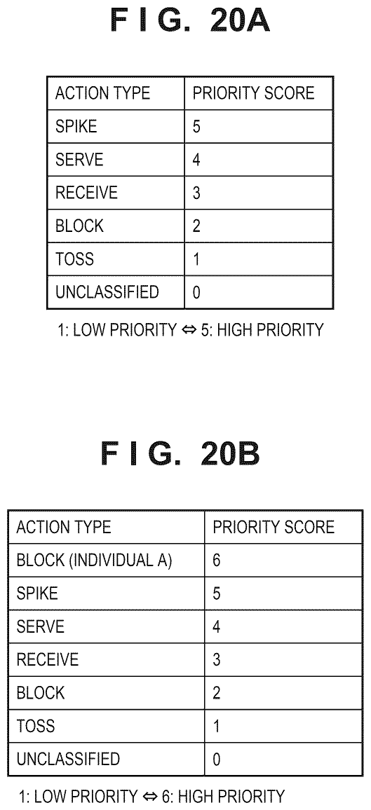

An application example of the fifth embodiment will be described next with reference to FIGS. 19A to 19C and FIGS. 20A and 20B.

In the present embodiment, in a case where there are a person with high priority and a registered person, high priority can be assigned to the registered person.

FIG. 19A exemplarily shows a scene in volleyball where a spike and a block have occurred simultaneously. Referring to FIG. 19A, a person 191 is performing a spiking action, and a person 192 is performing a blocking action. The person detection unit 102 detects the persons 191 and 192, and the action type detection unit 103 detects spike and block as action types as shown in FIG. 19B.

FIG. 20A exemplarily shows a priority model before correction. Performing priority assignment based on the priority model shown in FIG. 20A will assign a priority score of 5 to the person 191 who is spiking and a priority score of 2 to the person 192 who is blocking in FIG. 19A. Accordingly, the priority of the person 191 who is spiking increases. However, in the scene in FIG. 19A, in a case where the person 192 is a specific person whom the user wants to shoot, it is preferable to prioritize the person 192 over the person 191 performing an action with high priority. For this reason, priority assignment is performed in consideration of a person detected by personal authentication matches a registered person as well as action types.

In a case where the person 192 is a person whom the user wants to shoot and is registered as a registered person, it is determined by personal authentication that the person 192 is a person who matches the registered person, and a differentiated action type is set. FIG. 19C exemplarily shows a case where the action type is set to the action type differentiated by personal authentication with respect to the action type detection result without personal authentication in FIG. 19B. In the example shown in FIG. 19C, the person 192 is set to the action type that is differentiated as block (personal A). FIG. 20B exemplarily shows a corrected priority model. In the example shown in FIG. 20B, the priority score of the person who is blocking and matches the registered person is defined as 6, which is a priority score higher than that of spike. Priority assignment is performed by using the priority model in FIG. 20B to assign a priority score of 5 to the person 191 who is spiking and a priority score of 6 to the person 192 who is blocking, thus increasing the priority of the person 192 who is blocking in FIG. 19A. This makes it possible to assign the highest priority to the action type of a registered person if the registered person exists in the image.

### Sixth Embodiment

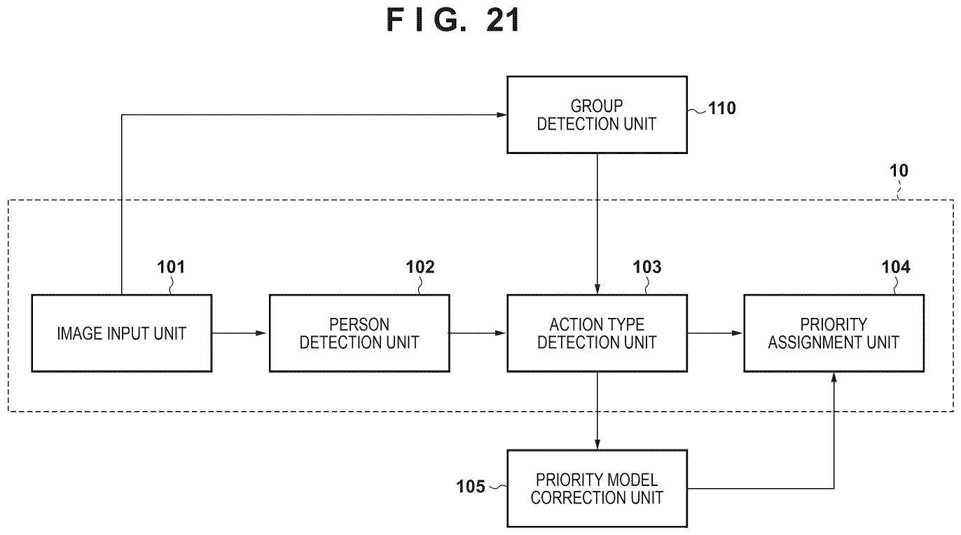

A sixth embodiment will be described next with reference to FIGS. 21 to 24B.

The hardware configuration of an image processing apparatus 10 according to the present embodiment is the same as that of the first embodiment in FIG. 1A. FIG. 21 is a block diagram exemplarily showing the functional configuration of the image processing apparatus 10 according to the present embodiment. The functional configuration of the image processing apparatus 10 according to the present embodiment is the same as that of the first embodiment except that the configuration shown in FIG. 1B further includes a group detection unit 110 and a priority model correction unit 105.

The group detection unit 110 determines, based on the person detection result obtained by a person detection unit 102, whether the uniform of the detected person matches a uniform registered in advance. The group detection result obtained by the group detection unit 110 is input to an action type detection unit 103. The action type detection unit 103 sets a person whose uniform matches a registered uniform to an action type that is differentiated from that of a person whose uniform does not match the registered uniform. The priority model correction unit 105 performs correction to increase the priority score of the person whose uniform matches the registered uniform based on the action type detection result obtained by the action type detection unit 103. This makes it possible to assign high priority to the person whose uniform matches the registered uniform.

### <Group Detection Processing and Priority Model Correction Processing>

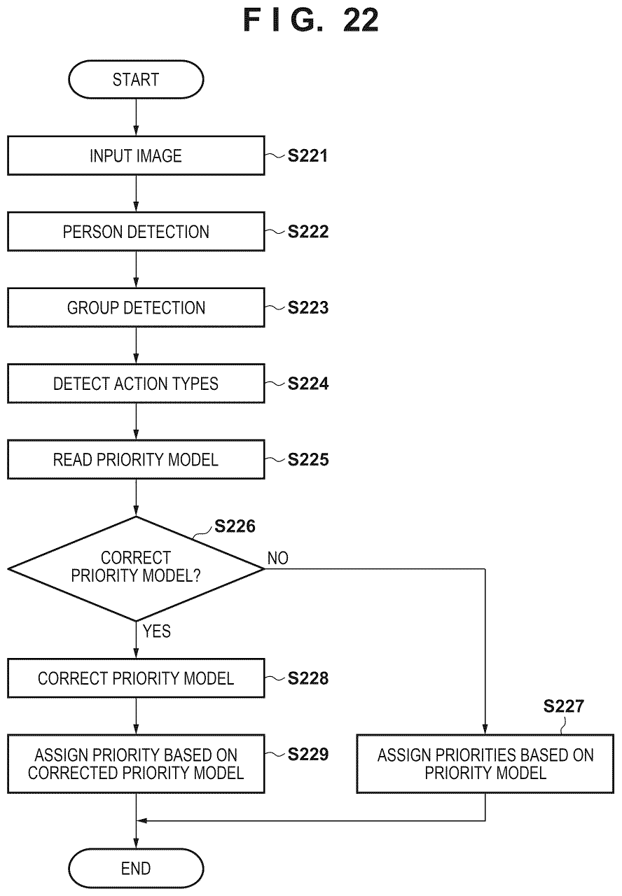

Priority assignment processing according to the sixth embodiment will be described next with reference to FIG. 22.

The processing in steps S221, S222, and S224 to S229 in FIG. 22 is the same as that in steps S101, S102, and S104 to S109 in FIG. 10.

After the processing in steps S221 and S222, the group detection unit 110 performs, in step S223, group detection with respect to the person detected in step S232. A group to be detected is designated in advance by registering a uniform image or the like. It is preferable to register an image depicting the front, side, and back surfaces of a uniform. Group detection is performed with respect to the person detected in step S222, and feature amounts are extracted from the registered uniform and the uniform of the detected person by inference processing. If the similarity between the two feature amounts is high, it can be determined that the detected uniform matches the registered group.

In step S224, the action type detection unit 103 detects an action type with respect to the person detected in step S222 as in the first embodiment. In addition, the action type detection unit 103 sets an action type that is differentiated from that of a person whose uniform does not match the registered uniform with respect to the person whose uniform is determined to match the uniform registered in step S223 in accordance with the action type detection result.

In step S225, a priority model is read. In step S226, it is determined whether it is necessary to correct the priority model. A case where it is determined that it is necessary to correct the priority model is a case where the action type detection result obtained in step S224 includes a differentiated action type. In a case where it is determined that it is not necessary to correct the priority model, a priority assignment unit 104 performs, in step S227, priority assignment by using the priority model read in step S225. In a case where it is determined that it is necessary to correct the priority model, the priority assignment unit 104 adds, in step S228, the differentiated action type and the definition of the corresponding priority score to the priority model read in step S225. The priority score is set to the value obtained by adding the highest priority score to the priority score before correction. With this processing, in a case where one person belongs to the designated group among a plurality of persons, the person of the group is always prioritized, whereas in a case where a plurality of persons belonging to the designated group are detected, a person of the group who has high priority in accordance with the action type is prioritized.

In step S229, the priority assignment unit 104 performs priority assignment by using the priority model corrected in step S228.

Note that a plurality of types of uniforms may be registered in advance, priorities are defined with respect to the registered uniforms, and priority scores may be set in correcting the priority model in consideration of the priorities of the uniforms.

### <Application Example>

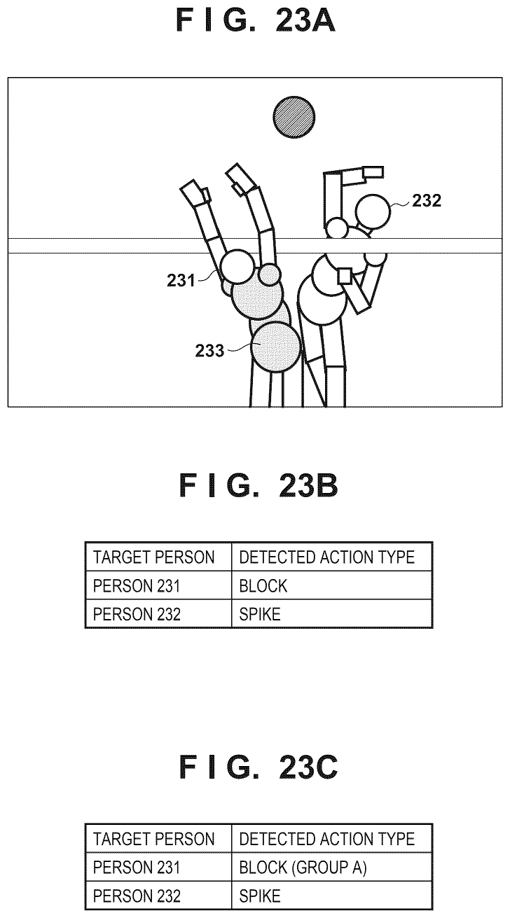

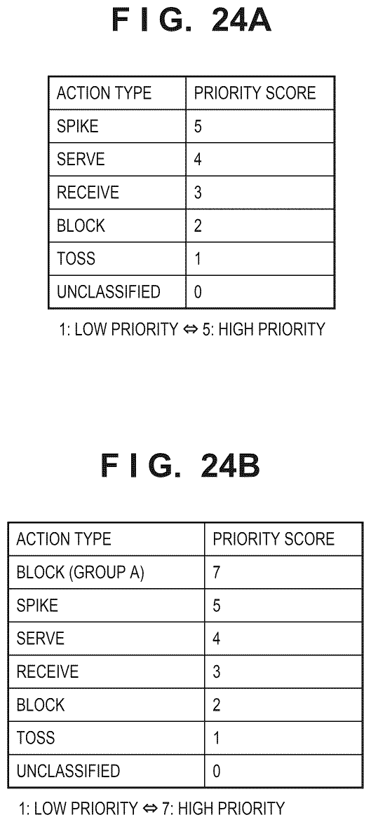

An application example of the sixth embodiment will be described next with reference to FIGS. 23A to 23C and FIGS. 24A and 24B.

In the present embodiment, in a case where there are a person performing an action with high priority and a person belonging to a group registered in advance, it is possible to assign high priority to the person belonging to the specific group.

FIG. 23A exemplarily shows a scene where a spike and a block have occurred simultaneously in volleyball. Referring to FIG. 23A, a person 231 is performing a blocking action, and a person 232 is performing a spiking action. The person detection unit 102 detects the persons 231 and 232. The action type detection unit 103 detects block and spike as action types, as shown in FIG. 23B. FIG. 24A exemplarily shows a priority model before correction. Performing priority assignment based on the priority model in FIG. 24A will assign a priority score of 5 to the person 232 who is spiking and a priority score of 2 to the person 231 who is blocking, thus increasing the priority of the person 232 who is spiking, as shown in FIG. 23A. However, in the scene shown in FIG. 23A, in a case where the person 231 is a person belonging to a specific group which the user wants to shoot, the user sometimes wants to prioritize the person 231 over the person 232 performing an action with high priority. Accordingly, in the present embodiment, priority assignment is performed in consideration of determination based on group detection whether the person belongs to the designated group as well as action types.

Assume that the group to which the person 231 belongs is a group which the user wants to shoot, and the uniform 233 of the person 231 is registered in advance. It is determined that the uniform 233 of the person 231 matches the uniform registered in advance by group detection, and the action type of the person 231 is set to an action type that is differentiated from another action type. FIG. 23C shows an example in which an action type that is differentiated by group detection is set with respect to an action type detection result. Referring to FIG. 23C, the person 231 is set to the action type that is differentiated from another action type as a block (group A). FIG. 24B exemplarily shows a corrected priority model. In the example shown in FIG. 24B, the priority score of block of a person belonging to the registered group is defined as 7, which is higher than the priority score of spike. Priority assignment is performed by using the priority model in FIG. 24B to assign a priority score of 7 to the person 231 who is blocking and assign a priority score of 5 to the person 232 who is spiking, whereby the person 231 who is blocking has higher priority than the person 232 who is spiking in FIG. 23A. This makes it possible to assign high priority to the person belonging to the registered group.

### Seventh Embodiment

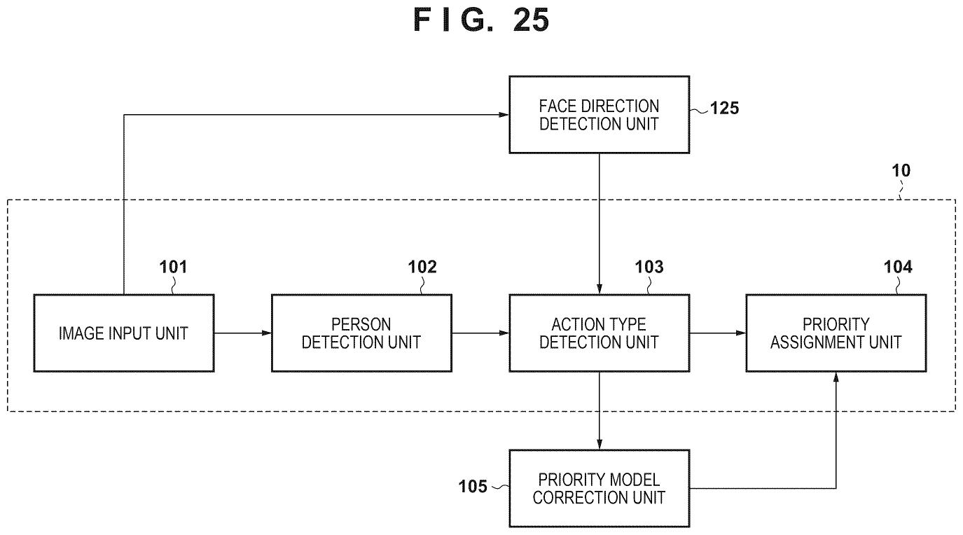

A seventh embodiment will be described next with reference to FIGS. 25 to 28B.

The hardware configuration of an image processing apparatus 10 according to the present embodiment is the same as that of the first embodiment in FIG. 1A. FIG. 25 is a block diagram exemplarily showing the functional configuration of the image processing apparatus 10 according to the present embodiment. The functional configuration of the image processing apparatus 10 according to the present embodiment is the same as that of the first embodiment except that the configuration shown in FIG. 1B further includes a face direction detection unit 125 and a priority model correction unit 105.

The face direction detection unit 125 determines the face direction of a detected person based on the person detection result obtained by a person detection unit 102. Assume that the back of the head is detected as a face direction. The face detection result obtained by the face direction detection unit 125 is input to an action type detection unit 103. The action type detection unit 103 sets the action type of the person whose back of the head is detected to an action type that is differentiated from the action type of one or more other persons. The priority model correction unit 105 performs correction to reduce the priority score of the person whose back of the head is detected based on the action type detection result obtained by the action type detection unit 103.

### <Face Direction Detection Processing and Priority Model Correction Processing>

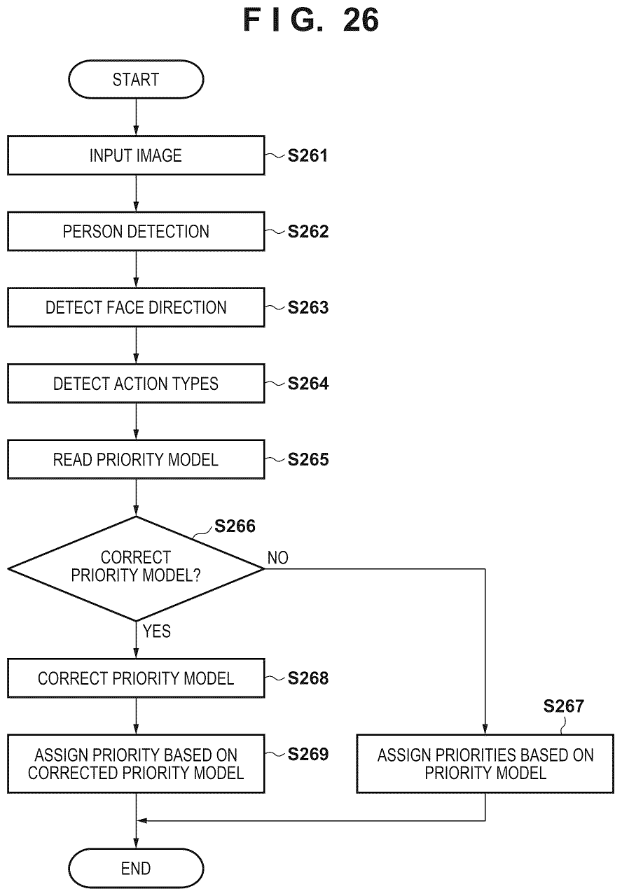

Priority assignment processing according to the seventh embodiment will be described next with reference to FIG. 26.

The priority assignment processing according to the seventh embodiment includes face direction detection processing and priority model correction processing based on a face direction detection result.

The processing in steps S261, S262, and S264 to S269 in FIG. 26 is the same as that in steps S101, S102, and S104 to S109 in FIG. 10.

After the processing in steps S261 and S262, the face direction detection unit 125 performs, in step S263, face direction detection with respect to the person detected in step S262. The back of the head is to be detected as a face direction, and face detection is performed with respect to the person. When the face is not detected, it is determined that the back of the head is detected.

In step S264, the action type detection unit 103 detects the action type of the person detected in step S262 as in the first embodiment. In addition, the action type detection unit 103 sets the action type of the person whose face direction is determined as the back of the head in step S263 to an action type that is differentiated from the action type of one or more other persons in accordance with the action type detection result.

In step S265, a priority model is read. In step S266, it is determined whether it is necessary to correct the priority model. A case where it is determined that it is necessary to correct the priority model is a case where the action type detection result obtained in step S265 includes a differentiated action type. When it is determined that it is not necessary to correct the priority model, a priority assignment unit 104 assigns, in step S267, a priority to each action type detected in step S264 by using the priority model read in step S265. When it is determined that it is necessary to correct the priority model, the priority assignment unit 104 adds, in step S268, the differentiated action type and the definition of the corresponding priority score to the priority model read in step S265. A priority score is set to be lower than a priority score before correction. In a case where the user wants to prioritize the priority score over a given action type even if the back of the head is detected, the priority score is set to be higher than the priority score of the given action type.

In step S269, the priority assignment unit 104 assigns a priority for each action type detected in step S264 by using the priority model corrected in step S268.

### <Application Example>

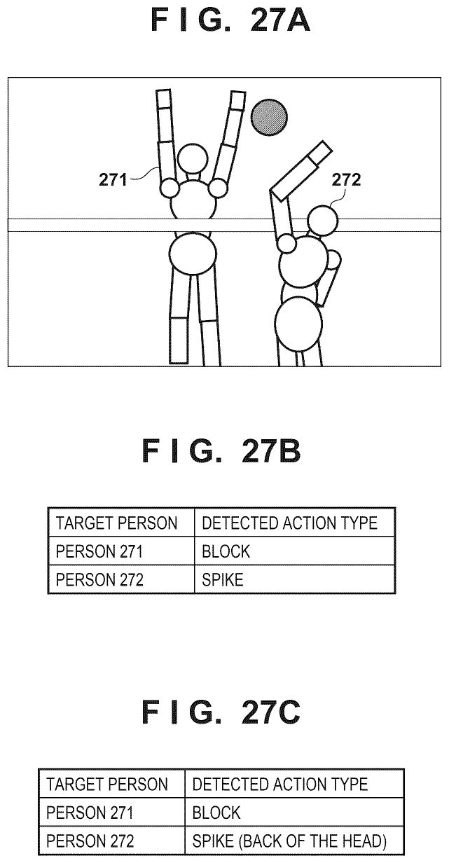

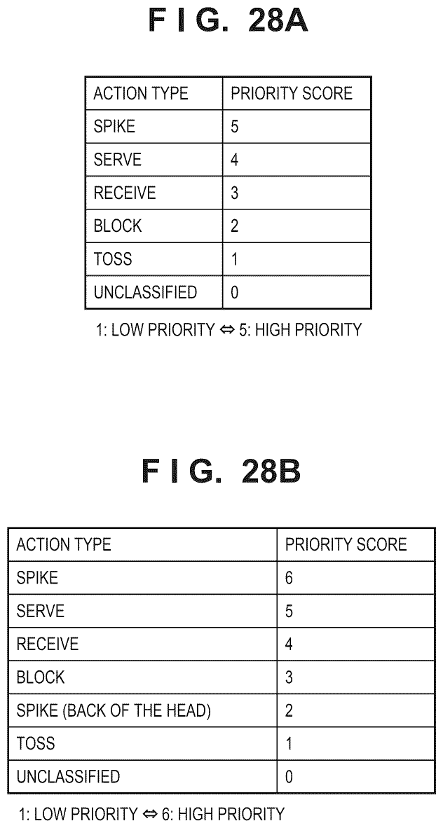

An application example of the seventh embodiment will be described next with reference to FIGS. 27A to 27C and FIGS. 28A and 28B.

In the present embodiment, in a case where the face direction of a person performing an action with high priority is the back of the head and the faces of one or more other persons performing an action with high priority is detected, a high priority is assigned to the person whose face is detected.

FIG. 27A shows a scene where a spike and a block occur simultaneously in volleyball. Referring to FIG. 25A, a person 271 is performing a blocking action, and a person 272 is performing a spiking action. The person detection unit 102 detects the persons 271 and 272. The action type detection unit 103 respectively detects the action types of the persons 271 and 272 as block and spike, as shown in FIG. 27B.

FIG. 28A exemplarily shows a priority model before correction. Performing priority assignment based on the priority model in FIG. 28A will assign a priority score of 2 to the person 271 who is blocking and a priority score of 5 to the person 272 who is spiking, thus increasing the priority of the person 272 who is spiking in FIG. 27A. In the scene in FIG. 27A, however, the back of the head of the person 272 may be detected instead of the face, and the user sometimes wants to prioritize the person 271 whose face is detected over the person 272 whose back of the head is detected. Accordingly, in the present embodiment, priority assignment is performed in consideration of whether the face of a person is detected by face detection as well as action types.

It is determined that the face of the person 271 is detected by face detection and the back of the head of the person 272 is detected. In action type detection, the action type of the person 272 whose back of the head is detected is set to an action type that is differentiated from the action type of the person 271 whose face is detected. FIG. 27C shows an example in which the action type of a person whose back of the head is detected is set to a differentiated action type based on a face direction detection result. Referring to FIG. 27C, the person 272 is set to the action type that is differentiated as spike (back of head). FIG. 28B exemplarily shows a corrected priority model. In the example shown in FIG. 28B, the priority score assigned when the face direction is the back of the head and the action type is spike is defined as 2, which is lower than that of block. Priority assignment is performed by using the priority model in FIG. 28B to assign a priority score of 3 to the person 271 who is blocking and a priority score of 2 to the person 272 whose back of the head is detected and who is spiking, thus increasing the priority of the person 271 who is blocking in FIG. 27A. This makes it possible to assign a higher priority to a person whose face is detected and who is performing blocking than to a person whose back of the head is detected and who is performing spiking.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-011659, filed Jan. 27, 2025 which is hereby incorporated by reference herein in its entirety.

What is claimed is:

1. An image processing apparatus comprising:
at least one processor; and
at least one memory which stores a program which, when executed by the at least one processor, causes the image processing apparatus to function as:
an image input unit that inputs an image;
a person detection unit that detects a person included in the image;
an action type detection unit that detects an action type of the detected person; and
a priority assignment unit that assigns a predetermined priority for each action type in accordance with the action type of the detected person.

2. The apparatus according to claim 1, wherein the priority assignment unit assigns a priority in accordance with the action type of the detected person by using a model in which a priority is assigned for each action type.

3. The apparatus according to claim 1, further comprising a storage unit that stores a table in which the action type and a priority for each action type are defined,
wherein the priority assignment unit assigns a priority in accordance with the action type of the detected person based on the table.

4. The apparatus according to claim 1, wherein the action type detection unit inputs divided images obtained by dividing the image into personal images including the detected person and detects the action type of the detected person by using a learned model.

5. The apparatus according to claim 1, wherein the at least one processor further functions as a selection unit that selects a predetermined subject from persons detected by the person detection unit based on priorities assigned by the priority assignment unit.

6. The apparatus according to claim 5, wherein the predetermined subject is a target subject for which predetermined control is performed.

7. The apparatus according to claim 6, wherein the predetermined control is control to focus on the predetermined subject in an image capture apparatus that captures the image.

8. The apparatus according to claim 2, wherein the at least one processor further functions as a model correction unit that corrects the model,
wherein the model correction unit determines whether to correct the model based on a combination of action types of a plurality of persons detected by the action type detection unit.

9. The apparatus according to claim 8, wherein the model correction unit corrects the model so as to assign a lowest priority when action types of a plurality of persons detected by the action type detection unit are the same.

10. The apparatus according to claim 8, wherein the at least one processor further functions as a key object detection unit that detects a key object from the image,
wherein the model correction unit determines whether to correct the model based on a detection result on the key object.

11. The apparatus according to claim 10, wherein the model correction unit corrects the model so as to make a priority corresponding to an action type of a person nearest to the key object become higher than a priority corresponding to an action type of one or more other persons performing the same action.

12. The apparatus according to claim 10, wherein the at least one processor further functions as a key frame detection unit that detects a key frame from an image input by the image input unit,
wherein the key frame detection unit detects the key frame based on a person detection result obtained by the person detection unit and a detection result on the key object, and
the model correction unit determines whether to correct the model based on a detection result on the key frame.

13. The apparatus according to claim 12, wherein the model correction unit corrects the model so as to make a priority corresponding to an action type of a person detected from an image having passed the key frame become lower than a priority corresponding to an action type of a person who is detected from an image before passing of the key frame and performs the same action.

14. The apparatus according to claim 8, wherein the at least one processor further functions as a personal authentication unit that detects a specific person from persons included in the image,
wherein the model correction unit determines whether to correct the model based on an authentication result obtained by the personal authentication unit.

15. The apparatus according to claim 14, wherein the model correction unit corrects the model so as to maximize a priority corresponding to an action type of the specific person among priorities corresponding to action types of the plurality of persons.

16. The apparatus according to claim 8, wherein the at least one processor further functions as a group detection unit that detects a group to which a person included in an image belongs,
wherein the model correction unit determines whether to correct the model based on a group detection result obtained by the group detection unit.

17. The apparatus according to claim 16, wherein the model correction unit corrects the model so as to maximize a priority corresponding to an action type of a person belonging to a specific group among priorities corresponding to action types of the plurality of persons.

18. The apparatus according to claim 8, wherein the at least one processor further functions as a face direction detection unit that detects a face direction of a person included in the image,
wherein the model correction unit determines whether to correct the model in accordance with the face direction.

19. The apparatus according to claim 18, wherein the model correction unit corrects the model so as to increase a priority corresponding to an action type of a person whose face is detected, among priorities corresponding to action types of the plurality of person, compared with a priority corresponding to an action type of a person whose face is not detected.

20. The apparatus according to claim 8, wherein the priority assignment unit assigns a priority in accordance with an action type of the detected person by using the model corrected by the model correction unit.

21. The apparatus according to claim 8, wherein the priority assignment unit assigns a priority in accordance with an action type of the detected person by using an uncorrected model in a case where the model is not corrected by the model correction unit.

22. The apparatus according to claim 1, wherein the action type includes an action characteristic to sport and an action that is not characteristic to the sport.

23. An image processing method executed by an image processing apparatus comprising:
inputting an image;
detecting a person included in the image;
detecting an action type of the detected person; and
assigning a predetermined priority for each action type in accordance with the action type of the detected person.

24. A non-transitory computer-readable storage medium storing a program for causing a computer to function as an image processing apparatus comprising:
an image input unit that inputs an image;
a person detection unit that detects a person included in the image;
an action type detection unit that detects an action type of the detected person; and
a priority assignment unit that assigns a predetermined priority for each action type in accordance with the action type of the detected person.
